(19) United States
(12) Patent Application Publication
(10) Pub. No.: US 2026/0095279 A1
(43) Pub. Date: Apr. 2, 2026

(54) SOUNDING 8 ANTENNA PORTS ON MULTIPLE OFDM SYMBOLS

(71) Applicant: Lenovo (Beijing) Limited, Beijing (CN)

(72) Inventors: Bingchao Liu, Beijing (CN); Chenxi Zhu, Fairfax, VA (US); Lingling Xiao, Beijing (CN); Yi Zhang, Beijing (CN); Wei Ling, Beijing (CN)

(73) Assignee: Lenovo (Beijing) Limited, Beijing (CN)

(21) Appl. No.: 19/112,028

(22) PCT Filed: Jan. 10, 2023
(86) PCT No.: PCT/CN2023/071519

§ 371 Date: Mar. 14, 2025

(51) Int. Cl. H04L 5/00

(52) U.S. Cl. CPC H04L 5/0007; H04L 5/0051; H04L 5/0094

(57) ABSTRACT

Methods and apparatuses for sounding 8 antenna ports on multiple OFDM symbols are disclosed. In one embodiment, a UE comprises a transceiver; and a processor coupled to the transceiver, wherein the processor is configured to receive, via the transceiver, a configuration to configure the number of OFDM symbols formula (I) for all 8 antenna ports sounding for one SRS resource transmission for an SRS resource with formula (II) SRS ports, and a configuration to configure one or more cyclic shifts and one or more comb offsets for the SRS resource; and determine cyclic shift value formula (III) and comb offset formula (IV) for each of 8 SRS ports in each of the OFDM symbols for the one SRS resource transmission for the SRS resource according to the configuration.

### FIELD

The subject matter disclosed herein generally relates to wireless communications, and more particularly relates to methods and apparatuses for sounding 8 antenna ports on multiple OFDM symbols.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Sounding Reference Signal (SRS), Physical Uplink Shared Channel (PUSCH), cyclic shift (CS), Time Division Duplex (TDD), The 3rd Generation Partnership Project (3GPP), technical specification (TS).

SRS is used for UL channel estimation for UL scheduling. The gNB can also obtain the DL channel or some parameters of the DL channel by SRS based on channel reciprocity for TDD system.

In frequency domain, SRS has a comb structure, implying that an SRS is transmitted on every K^{th} subcarrier of the sounding bandwidth, where K can be 2, 4 or 8 corresponding to comb-2, comb-4 or comb-8, which can be represented by K_{TC}=2 or 4 or 8. Different SRS ports of a same SRS resource can be frequency multiplexed by being assigned with different comb offsets. For example, when comb-2 (K_{TC}=2) is configured for a SRS resource with two SRS ports, all the odd subcarriers, which correspond to a comb offset value, are assigned to one SRS port and all the even subcarriers, which correspond to another comb offset value, are assigned to the other SRS port.

In sequence domain, orthogonal sequences can be assigned to different SRS ports of a SRS resource by assigning different cyclic shifts (CSs) of a same SRS sequence. Since different CSs of a SRS sequence is equivalent to a phase rotation in frequency domain, the number of available CSs named the maximum number of CSs corresponding to different comb sizes is limited as in Table 1, which is Table 6.4.1.4.2-1 specified in 3GPP TS38.211 V17.2.0.

TABLE 1
$Maximum number of cyclic shifts ( {n}_{SRS}^{cs , max} ) as a function of {K}_{TC}$

| K_{TC} | ${n}_{SRS}^{cs , max}$ |
|---|---|
| 2 | 8 |
| 4 | 12 |
| 8 | 6 |

In NR Release 18, up to 8 layers PUSCH was agreed to be supported for advance devices with 8 antenna ports, i.e., 8Tx UE. 8 ports SRS will be supported as well for UL channel sounding for codebook based PUSCH transmission for 8 Tx UE. In addition to sounding all 8 antenna ports in one OFDM symbol, it was agreed to support to sound all 8 antenna ports in multiple OFDM symbols to increase SRS coverage.

This disclosure targets detailed design for sounding 8 antenna ports in multiple OFDM symbols in a same SRS resource.

### BRIEF SUMMARY

Methods and apparatuses for sounding 8 antenna ports on multiple OFDM symbols are disclosed.

In one embodiment, a UE comprises a transceiver; and a processor coupled to the transceiver, wherein the processor is configured to receive, via the transceiver, a configuration to configure the number of OFDM symbols

$$( {N}_{symb}^{SRS , Resource} )$$

for all 8 antenna ports sounding for one SRS resource transmission for an SRS resource with

$${N}_{a p}^{S R S} = 8 SRS ports ,$$

and a configuration to configure one or more cyclic shifts and one or more comb offsets for the SRS resource; and determine cyclic shift value α_{p̅}_{ᵢ} and comb offset

$${k}_{T C}^{( {\overline{p}}_{i} )}$$

for each of 8 SRS ports in each of the OFDM symbols for the one SRS resource transmission for the SRS resource according to the configuration.

In some embodiment, the configuration is by directly configuring the number of OFDM symbols

$$( {N}_{s y m b}^{SRS , Resource} ) ,$$

which is 2 or 4. Alternatively, the configuration is by configuring the number of SRS ports in each OFDM symbol

$$( {N}_{a p}^{S R S , symbol} ) ,$$

which is equal to

$${N}_{a p}^{S R S} / {N}_{symb}^{SRS , Resource}$$

and is 4 or 2.

In some embodiment, the processor is further configured to split a linear value \hat{P}_{SRS,bf,c}(i, qₛ, l) of the transmit power P_{SRS,bf,c}(i, qₛ, l) on active UL BWP b of carrier f of serving cell c equally across

$${N}_{a p}^{S R S , symbol}$$

antenna ports for the SRS transmission in one OFDM symbol, where

$${N}_{a p}^{SRS , symbol} = {N}_{a p}^{S R S} / {N}_{s y m b}^{SRS , Resource} .$$

In some embodiment, each of SRS ports 0, . . . ,

$${N}_{a p}^{S R S , symbol} - 1$$

in each OFDM symbol for all SRS resource transmission share a same cyclic shift value α_{p̅}_{ᵢ} and a same comb offset

$${k}_{T C}^{( {\overline{p}}_{i} )}$$

when a single cyclic shift and a single comb offset are configured for the SRS resource.

If

$${N}_{symb}^{SRS , Resource} = 2 ,$$

the cyclic shift values SRS port 0, 1, 2, 3 (p̅ᵢ=0, 1, 2, 3) in a first OFDM symbol and in a second OFDM symbol are determined according to

$${n}_{SRS}^{cs , {\overline{p}}_{i}} = \{ \begin{matrix}( {n}_{SRS}^{cs} + \frac{{n}_{SRS}^{cs , max} ⌊ {\overline{p}}_{i} / 2 ⌋}{{N}_{ap}^{SRS} / 2} ) mod {n}_{SRS}^{cs , max} & {n}_{SRS}^{cs , max} = 6 \\ ( {n}_{SRS}^{cs} + \frac{{n}_{SRS}^{cs , max} \times {\overline{p}}_{i}}{{N}_{ap}^{SRS}} ) mod {n}_{SRS}^{cs , max} & {n}_{SRS}^{cs , max} = 8 or 12\end{matrix} ,$$

where

$${n}_{S R S}^{c s}$$

is the single cyclic shift configured for the SRS resource.

If

$${N}_{symb}^{SRS , Resource} = 2 ,$$

the comb offsets for SRS port 0, 1, 2, 3 (p̅ᵢ=0, 1, 2, 3) in a first OFDM symbol and in a second OFDM symbol are determined according to

$$\{ \begin{matrix}( {\overline{k}}_{TC} + {K}_{TC} / 2 ) mod {K}_{TC} & {\overline{p}}_{i} ∈ \{ 1 , 3 \} , {n}_{SRS}^{cs , max} = 6 \\ ( {\overline{k}}_{TC} + {K}_{TC} / 2 ) mod {K}_{TC} & {\overline{p}}_{i} ∈ \{ 1 , 3 \} , {n}_{SRS}^{cs} ∈ \{ {n}_{SRS}^{cs , max} / 2 , … , {n}_{SRS}^{cs , max} - 1 \} \\ {\overline{k}}_{TC} & \begin{matrix}{\overline{p}}_{i} ∈ \{ 1 , 3 \} , {n}_{SRS}^{cs} ∈ \\ \{ 0 , … , {n}_{SRS}^{cs , max} / 2 \} or {p}_{i} ∈ \{ 0 , 2 \}\end{matrix}\end{matrix} ,$$

where K_{TC} is the comb size configured for the SRS resource, k̅_{TC} is the single comb offset configured for the SRS resource.

If

$${N}_{symb}^{SRS , Resource} = 4 ,$$

the cyclic shift values for SRS ports 0, 1 (p̅ᵢ=0, 1) in a first OFDM symbol, in a second OFDM symbol, in a third OFDM symbol and in a fourth OFDM symbol are determined according to

$${α}_{{\overline{p}}_{i}} = 2 π \frac{{n}_{SRS}^{cs , {\overline{p}}_{i}}}{{n}_{SRS}^{cs , max}} , where {n}_{SRS}^{cs , {\overline{p}}_{i}} = ( {n}_{SRS}^{cs} + \frac{{n}_{SRS}^{cs , max} \times {\overline{p}}_{i}}{{N}_{ap}^{SRS}} ) mod {n}_{SRS}^{cs , max} ,$$

where

$${n}_{SRS}^{c s}$$

is the single cyclic shift configured for the SRS resource.

If

$${N}_{symb}^{SRS , Resource} = 4 ,$$

the comb offsets for SRS ports 0, 1 (p̅ᵢ=0, 1) in a first OFDM symbol, in a second OFDM symbol, in a third OFDM symbol and in a fourth OFDM symbol are determined according to

$${k}_{TC}^{( {\overline{p}}_{i} )} = {\overline{k}}_{TC} ,$$

where k̅_{TC} is the single comb offset configured for the SRS resource.

In some embodiment, SRS port 0, . . . ,

$${N}_{ap}^{SRS , symbol} - 1$$

in each OFDM symbol for all SRS resource transmission are associated with different antenna ports.

In some embodiment, the processor is further configured to report a partial coherent capability with multiple antenna groups, and all antenna ports within a same antenna group are associated with the SRS ports of the SRS resource transmission in a same OFDM symbol.

In some embodiment, when the SRS resource is further configured with frequency hopping, the number of SRS transmissions is counted according to

$${n}_{SRS} = ⌊ \frac{{l}^{′}}{R \times {N}_{symb}^{SRS , Resource}} ⌋$$

for aperiodic SRS resource, or

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R \times {N}_{symb}^{SRS , Resource}} ) + ⌊ \frac{{l}^{′}}{R \times {N}_{symb}^{SRS , Resource}} ⌋$$

for periodic and semi-persistent SRS.

In some embodiment, when the SRS resource is further configured with repetition, the number of OFDM symbols for the SRS transmission is a multiple of

$${N}_{symb}^{SRS , Resource} .$$

In another embodiment, a method performed at a UE comprises receiving a configuration to configure the number of OFDM symbol

$$( {N}_{symb}^{SRS , Resource} )$$

for all 8 antenna ports sounding for one SRS resource transmission for an SRS resource with

$${N}_{ap}^{SRS} = 8 SRS ports ,$$

and a configuration to configure one or more cyclic shifts and one or more comb offsets for the SRS resource; and determining cyclic shift value α_{p̅}_{ᵢ} and comb offset

$${k}_{TC}^{( {\overline{p}}_{i} )}$$

for each of 8 SRS ports in each of the OFDM symbols for the one SRS resource transmission for the SRS resource according to the configuration.

In still another embodiment, a base unit comprises a transceiver; and a processor coupled to the transceiver, wherein the processor is configured to transmit, via the transceiver, a configuration to configure the number of OFDM symbols

$$( {N}_{symb}^{SRS , Resource} )$$

for all 8 antenna ports sounding for one SRS resource transmission for an SRS resource with

$${N}_{ap}^{SRS} = 8$$

SRS ports, and a configuration to configure one or more cyclic shifts and one or more comb offsets for the SRS resource; and determine cyclic shift value α_{p̅}_{ᵢ} and comb offset

$${k}_{TC}^{( {\overline{p}}_{i} )}$$

each of 8 SRS ports in each of the OFDM symbols for the one SRS resource transmission for the SRS resource according to the configuration.

In yet another embodiment, a method performed at a base unit comprises transmitting a configuration to configure the number of OFDM symbols

$$( {N}_{symb}^{SRS , Resource} )$$

for all 8 antenna ports sounding for one SRS resource transmission for an SRS resource with

$${N}_{ap}^{SRS} = 8$$

SRS ports, and a configuration to configure one or more cyclic shifts and one or more comb offsets for the SRS resource; and determining cyclic shift value α_{p̅}_{ᵢ} and comb offset

$${k}_{TC}^{( {\overline{p}}_{i} )}$$

for each of 8 SRS ports in each of the OFDM symbols for the one SRS resource transmission for the SRS resource according to the configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1(a) illustrates fully coherent antenna layout;

FIG. 1(b) illustrates non-coherent antenna layout;

FIG. 1(c) illustrates partial-coherent antenna layout 1;

FIG. 1(d) illustrates partial-coherent antenna layout 2;

FIG. 2(a) illustrates an example of frequency hopping for sounding 8 antenna ports on 2 symbols;

FIG. 2(b) illustrates an example of repetition for sounding 8 antenna ports on 2 symbols;

FIG. 3 is a schematic flow chart diagram illustrating an embodiment of a method;

FIG. 4 is a schematic flow chart diagram illustrating an embodiment of another method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

First, an introduction on the antenna layout is provided.

Different antenna groups can be configured for different antenna layouts. For discussion purpose, a concept of “coherent antenna group” is used in this disclosure. Coherent antenna group is defined as: all antenna ports within a same coherent antenna group are coherent, which means that all the antenna ports within the same coherent antenna group can be used for transmission of one PUSCH layer, and that antenna ports from different coherent antenna groups are non-coherent, which means that antenna ports from different coherent antenna groups cannot be used for transmission of one PUSCH layer.

All the antenna ports within one coherent antenna group (which means that these antenna ports are coherent antenna ports) can be used for transmission of one PUSCH layer. Different coherent antenna groups can be used for transmission of different PUSCH layers.

From the channel estimation point of view, the phase difference between coherent antennas for a certain channel condition is fixed. Thus, co-phase based precoding on the coherent antenna port transmission is supported on the precoding design. However, the phase difference between non-coherent antenna ports is random. So, non-coherent antenna ports cannot be used for co-phase based transmission. Therefore, a PUSCH layer can only be transmitted on a set of coherent antenna ports.

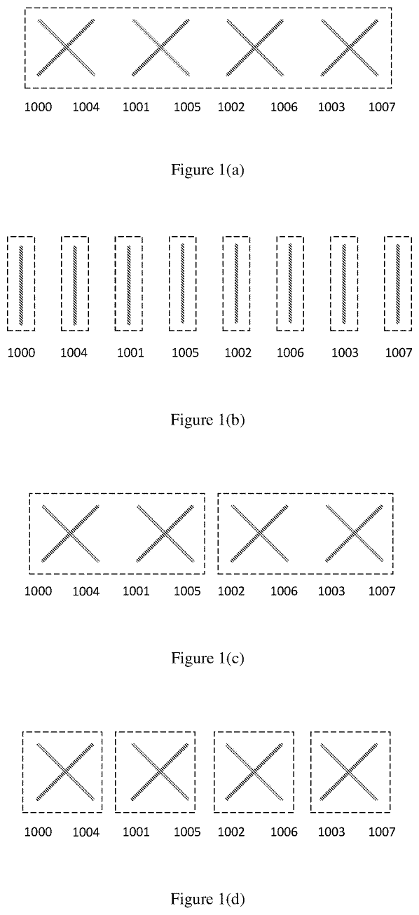

FIGS. 1(a) to 1(d) illustrate different antenna layouts for 8 antenna ports. The 8 antenna ports may be numbered as antenna ports 1000, 1001, 1002, 1003, 1004, 1005, 1006, and 1007.

FIG. 1(a) illustrates fully coherent antenna layout, in which all antenna ports 1000, 1001, 1002, 1003, 1004, 1005, 1006, and 1007 belong to one coherent antenna group. That is, there is one coherent antenna group in the fully coherent antenna layout, where the one coherent antenna group contains eight antenna ports.

FIG. 1(b) illustrates non-coherent antenna layout, in which each of antenna ports 1000, 1001, 1002, 1003, 1004, 1005, 1006, and 1007 belongs to a different coherent antenna group. That is, there are eight coherent antenna groups in the non-coherent antenna layout, where each of the eight coherent antenna groups contains one antenna port.

FIG. 1(c) illustrates partial-coherent antenna layout 1, in which four antenna ports (e.g. antenna ports 1000, 1001, 1004, and 1005) belong to one coherent antenna group, and the other four antenna ports (e.g. antenna ports 1002, 1003, 1006, and 1007) belong to the other coherent antenna group. That is, there are two coherent antenna groups in the partial-coherent antenna layout 1, where each of the two coherent antenna groups contains four antenna ports.

FIG. 1(d) illustrates partial-coherent antenna layout 2, in which two antenna ports belong to one coherent antenna group. For example, antenna ports 1000 and 1004 belong to a first coherent antenna group; antenna ports 1001 and 1005 belong to a second coherent antenna group; antenna ports 1002 and 1006 belong to a third coherent antenna group; and antenna ports 1003 and 1007 belong to a fourth coherent antenna group. That is, there are four coherent antenna groups in the partial-coherent antenna layout 2, where each of the four coherent antenna groups contains two antenna ports.

When a SRS resource is configured with 8 SRS ports, i.e., higher layer parameter nrofSRS-Ports is set to 8

$$( {N}_{ap}^{SRS} = 8 ) ,$$

the gNB can further configure the number of OFDM symbols for all the 8 antenna ports sounding for one SRS resource transmission, e.g., by directly configuring the number of OFDM symbols by RRC parameter nrofSymbolsPerResource

$$( {N}_{symb}^{SRS , Resource} ) ,$$

or by configuring the number of SRS ports for the SRS transmission in each OFDM symbol, e.g., by RRC parameter nrofSRS-PortsPerSymbol

$$( {N}_{ap}^{SRS , symbol} ) \cdot {N}_{ap}^{SRS , symbol} = {N}_{ap}^{SRS} / {N}_{symb}^{SRS , Resource} .$$

In the following description, OFDM symbol is abbreviated as symbol.

The 8 SRS ports can be numbered as SRS port 0, SRS port 1, SRS port 2, SRS port 3, SRS port 4, SRS port 5, SRS port 6 and SRS port 7 (i.e., SRS port p̅ᵢ=0, 1, 2, 3, 4, 5, 6 and 7).

This disclosure proposes that the 8 SRS ports are sounded in 2 symbols or in 4 symbols.

A first embodiment relates to determination of cyclic shift and comb offset.

A first sub-embodiment of the first embodiment relates to determination of cyclic shift and comb offset for each SRS port if the 8 SRS ports are sounded in 2 symbols (i.e.,

$${N}_{symb}^{SRS , Resource} = 2 , or {N}_{ap}^{SRS , symbol} = 4 ) .$$

A configuration of

$${N}_{symb}^{SRS , Resource} = 2$$

(i.e., the number of symbols for sounding 8 antenna ports is 2) or a configuration of

$${N}_{ap}^{SRS , symbol} = 4$$

(i.e., the number of SRS ports for the SRS transmission in each symbol is 4) can configure the UE that the 8 SRS ports are sounded in 2 symbols.

When the 8 SRS ports are sounded in 2 symbols, each SRS resource transmission shall occupy two adjacent symbols, where SRS transmission in each of the two symbols is transmitted with 4 SRS ports, e.g., p̅ᵢ=0, 1, 2, 3 in the first symbol and p̅ᵢ=4, 5, 6, 7 in the second symbol. In this condition, SRS port 0, SRS port 1, SRS port 2 and SRS port 3, that are sounded in the first symbol, can be represented as SRS port 0 (or first SRS port) in the first symbol, SRS port 1 (or second SRS port) in the first symbol, SRS port 2 (or third SRS port) in the first symbol and SRS port 3 (or fourth SRS port) in the first symbol, respectively, while SRS port 4, SRS port 5, SRS port 6 and SRS port 7, that are sounded in the second symbol, can be represented as SRS port 0 (or first SRS port) in the second symbol, SRS port 1 (or second SRS port) in the second symbol, SRS port 2 (or third SRS port) in the second symbol and SRS port 3 (or fourth SRS port) in the second symbol, respectively.

In the condition that one

$${n}_{S R S}^{c s}$$

(cyclic shift) and one k̅_{TC} (comb offset) are configured for the SRS resource, the UE shall determine the cyclic shift value for each SRS port p̅ᵢ=0, 1, 2, 3 (i.e., SRS port 0, SRS port 1, SRS port 2 and SRS port 3 in the first symbol) according to

$${n}_{SRS}^{cs , {\overline{p}}_{i}} = \{ \begin{matrix}( {n}_{SRS}^{cs} + \frac{{n}_{SRS}^{cs , max} ⌊ {\overline{p}}_{i} / 2 ⌋}{{N}_{ap}^{SRS} / 2} ) mod {n}_{SRS}^{cs , max} & {n}_{SRS}^{cs , max} = 6 \\ ( {n}_{SRS}^{cs} + \frac{{n}_{SRS}^{cs , max} \times {\overline{p}}_{i} ⌋}{{N}_{ap}^{SRS}} ) mod {n}_{SRS}^{cs , max} & {n}_{SRS}^{cs , max} = 8 or 12\end{matrix} ,$$

where

$${n}_{S R S}^{c s}$$

is the single cyclic shift configured for the SRS resource.

$${n}_{SRS}^{cs , max} = 6 ,$$

8 or 12 is determined by the configured comb size for the SRS resource according to Table 6.4.1.4.2-1 specified in 3GPP TS38.211 V17.2.0.

Each of SRS ports p̅ᵢ=4, 5, 6, 7 (i.e., SRS port 0, SRS port 1, SRS port 2 and SRS port 3 in the second symbol) share the same cyclic shift value as each of SRS ports p̅ᵢ=0, 1, 2, 3 (i.e., SRS port 0, SRS port 1, SRS port 2 and SRS port 3 in the first symbol), respectively. It means that each SRS port p (where p is from 0 to

$${N}_{ ap}^{RSS , symbol} ,$$

i.e., from 0 to 3 in the first sub-embodiment) in the second symbol shares the same cyclic shift value as the SRS port p in the first symbol.

In the condition that one

$${n}_{SRS}^{c s}$$

(cyclic shift) and one k̅_{TC} (comb offset) are configured for the SRS resource, the UE shall determine the comb offset for each SRS port p̅ᵢ=0, 1, 2, 3 according to

$$\{ \begin{matrix}( {\overline{k}}_{T C} + {K}_{T C} / 2 ) mod {K}_{T C} & {\overline{p}}_{i} ∈ \{ 1 , 3 \} , {n}_{S R S}^{cs , max} = 6 \\ ( {\overline{k}}_{T C} + {K}_{T C} / 2 ) mod {K}_{T C} & {\overline{p}}_{i} ∈ \{ 1 , 3 \} , {n}_{S R S}^{c s} ∈ \{ {n}_{S R S}^{cs , max} / 2 , … , {n}_{S R S}^{cs , max} - 1 \} \\ {\overline{k}}_{T C} & \begin{matrix}{\overline{p}}_{i} ∈ \{ 1 , 3 \} , {n}_{S R S}^{c s} ∈ \{ 0 , … , {n}_{S R S}^{cs , max} / 2 \} or \\ {\overline{p}}_{i} ∈ \{ 0 , 2 \}\end{matrix}\end{matrix} , \begin{matrix} \\ \end{matrix}$$

where K_{TC} is the comb size configured for the SRS resource, k̅_{TC} is the comb offset configured for the SRS resource, and

$${n}_{S R S}^{cs , max} = 6 ,$$

8 or 12 is determined by the configured comb size for the SRS resource according to Table 6.4.1.4.2-1 specified in 3GPP TS38.211 V17.2.0.

Each of SRS ports p̅ᵢ=4, 5, 6, 7 share the same comb offset as each of SRS ports p̅ᵢ=0, 1, 2, 3, respectively. It means that each SRS port p (where p is from 0 to

$${N}_{ap}^{SRS , symbol} ,$$

i.e., from 0 to 3 in the first sub-embodiment) in the second symbol shares the same comb offset as the SRS port p in the first symbol.

Alternatively to configuring one

$${n}_{S R S}^{c s}$$

and one k̅_{TC} for the SRS resource, when

$${N}_{s y m b}^{SRS , Resource} = 2 ,$$

or

$${N}_{a p}^{S R S , s y mbol} = 4 ,$$

the gNB may configure two

$${n}_{S R S}^{c s}$$

(a first

$${n}_{S R S}^{c s}$$

and a second

$${n}_{S R S}^{c s} )$$

and two k̅_{TC} (a first k̅_{TC} and a second k̅_{TC}) for the SRS resource, where the first

$${n}_{S R S}^{c s}$$

and the first k̅_{TC} are used for the UE to determine the cyclic shift value and the comb offset for each of the SRS port in the first symbol, and the second

$${n}_{S R S}^{c s}$$

and the second k̅_{TC} are used for the UE to determine the cyclic shift value and the comb offset for each of the SRS port in the second symbol. A same K_{TC} (comb size) is configured for the SRS resource. With this configuration, SRS port 0, 1, 2, 3 in the first symbol may determine different cyclic shift values and different comb offset values from the SRS port 0, 1, 2, 3 in the second symbol.

The SRS ports for the SRS transmission in the first symbol and in the second symbol are associated with different UE antenna ports. There are two patterns for the association of the SRS ports for the SRS transmission with UE antenna ports.

Pattern 1-1: SRS ports p̅ᵢ=0, 1, 2, 3 (i.e., SRS ports 0, 1, 2, 3 in the first symbol) for the SRS resource transmission are associated with antenna ports 1000, 1001, 1002, 1003, respectively; and SRS ports p̅ᵢ=4, 5, 6, 7 (i.e., SRS ports 0, 1, 2, 3 in the second symbol) for the SRS resource transmission are associated with antenna ports 1004, 1005, 1006, 1007, respectively.

Pattern 1-2: SRS ports p̅ᵢ=0, 1, 2, 3 (i.e., SRS ports 0, 1, 2, 3 in the first symbol) for the SRS resource transmission are associated with antenna ports 1000, 1001, 1004, 1005, respectively; and SRS ports p̅ᵢ=4, 5, 6, 7 (i.e., SRS ports 0, 1, 2, 3 in the second symbol) for the SRS resource transmission are associated with antenna ports 1002, 1003, 1006, 1007, respectively. It can be seen from Pattern 1-2 that at least for partial coherent UE, all the antenna ports within a same coherent antenna group (e.g., antenna ports 1000, 1001, 1004, 1005 that are in a same coherent antenna group, and antenna ports 1002, 1003, 1006, 1007 that are in a same coherent antenna group: see FIG. 1(c)) are sounded in a same symbol.

A second sub-embodiment of the first embodiment relates to determination of cyclic shift and comb offset if 8 SRS ports are sounded in 4 symbols (i.e.,

$${N}_{s y m b}^{SRS , Resource} = 4 , or$$

$${N}_{ap}^{SRS , symbol} = 2 ) .$$

A configuration of

$${N}_{s y m b}^{SRS , Resource} = 4$$

(i.e., the number of symbols for sounding 8 antenna ports is 4), or a configuration of

$${N}_{a p}^{S R S , s y mbol} = 2$$

(i.e., the number of SRS ports for the SRS transmission in each symbol is 2) can configure the UE that the 8 SRS ports are sounded in 4 symbols.

When the 8 SRS ports are sounded in 4 symbols, each SRS resource transmission shall occupy four adjacent symbols, where SRS transmission in each of the four symbols is transmitted with 2 SRS ports, e.g., p̅ᵢ=0, 1 in the first symbol, p̅ᵢ=2, 3 in the second symbol, p̅ᵢ=4, 5 in the third symbol, and p̅ᵢ=6, 7 in the fourth symbol. In this condition, SRS port 0 and SRS port 1, that are sounded in the first symbol, can be represented as SRS port 0 (or first SRS port) in the first symbol and SRS port 1 (or second SRS port) in the first symbol; SRS port 2 and SRS port 3, that are sounded in the second symbol, can be represented as SRS port 0 in the second symbol (or first SRS port) and SRS port 1 (or second SRS port) in the second symbol; SRS port 4 and SRS port 5, that are sounded in the third symbol, can be represented as SRS port 0 (or first SRS port) in the third symbol and SRS port 1 (or second SRS port) in the third symbol; and SRS port 6 and SRS port 7, that are sounded in the fourth symbol, can be represented as SRS port 0 (or first SRS port) in the fourth symbol and SRS port 1 (or second SRS port) in the fourth symbol.

In the condition that one

$${n}_{S R S}^{c s}$$

(cyclic shift) and one k̅_{TC} (comb offset) are configured for the SRS resource, the UE shall determine the cyclic shift value for each SRS port p̅ᵢ=0, 1 (i.e., SRS port 0, 1 in the first symbol) according to

$${α}_{{\overline{p}}_{i}} = 2 π \frac{{n}_{SRS}^{cs , {\overline{p}}_{i}}}{{n}_{SRS}^{cs , max}} ,$$

where

$${n}_{S R S}^{c s , {\overline{p}}_{i}} = ( {n}_{S R S}^{c s} + \frac{{n}_{S R S}^{cs , max} \times {\overline{p}}_{i}}{{N}_{a p}^{S R S}} ) mod {n}_{S R S}^{cs , max} ,$$

where

$${n}_{S R S}^{c s}$$

is the cyclic shift configured for the SRS resource,

$${n}_{S R S}^{cs , max} = 6 ,$$

8 or 12 is determined by the configured comb size for the SRS resource according to Table 6.4.1.4.2-1 specified in 3GPP TS38.211 V17.2.0.

Each of SRS ports p̅ᵢ=2, 3 (i.e., each of SRS port 0, 1 in the second symbol), each of SRS ports p̅ᵢ=4, 5 (i.e., each of SRS port 0, 1 in the third symbol) and each of SRS ports p̅ᵢ=6, 7 (i.e., each of SRS port 0, 1 in the fourth symbol) share the same cyclic shift value as each of SRS ports p̅ᵢ=0, 1, respectively. It means that each SRS port p (where p is from 0 to

$${N}_{a p}^{S R S , symbol} ,$$

i.e., from 0 to 1 in the second sub-embodiment) in each of the second symbol, the third symbol and the fourth symbol shares the same cyclic shift value as the SRS port p in the first symbol.

In the condition that one

$${n}_{S R S}^{c s}$$

(cyclic shift) and one k̅_{TC} (comb offset) are configured for the SRS resource, the UE shall determine the comb offset for each SRS port p̅ᵢ=0, 1 according to

$${k}_{T C}^{( {\overline{p}}_{i} )} = {\overline{k}}_{T C} ,$$

where k̅_{TC} is the comb offset configured for the SRS resource.

Each of SRS ports p̅ᵢ=2, 3 (i.e., each of SRS port 0, 1 in the second symbol), each of SRS ports p̅ᵢ=4, 5 (i.e., each of SRS port 0, 1 in the third symbol) and each of SRS ports p̅ᵢ=6, 7 (i.e., each of SRS port 0, 1 in the fourth symbol) share the same comb offset as each of SRS ports p̅ᵢ=0, 1, respectively. It means that each SRS port p (where p is from 0 to

$${N}_{ap}^{SRS , symbol} ,$$

i.e., from 0 to 1 in the second sub-embodiment) in each of the second symbol, the third symbol and the fourth symbol shares the same comb offset as the SRS port p in the first symbol.

Alternatively to configuring one

$${n}_{S R S}^{c s}$$

and one k̅_{TC} for the SRS resource, when

$${N}_{s y m b}^{SRS , Resource} = 4 , or {N}_{a p}^{SRS , symbol} = 2 ,$$

the gNB may config four

$${n}_{S R S}^{c s}$$

(a first

$${n}_{S R S}^{c s} ,$$

a second

$${n}_{S R S}^{c s} ,$$

a third

$${n}_{S R S}^{c s}$$

and a fourth

$${n}_{S R S}^{c s} )$$

and four k̅_{TC} (a first k̅_{TC}, a second k̅_{TC}, a third k̅_{TC} and a fourth k̅_{TC}) for the SRS resource, where the first

$${n}_{S R S}^{c s}$$

and the first k̅_{TC} are used for the UE to determine the cyclic shift value and the comb offset for each of the SRS port in the first symbol, the second

$${n}_{S R S}^{c s}$$

and the second k̅_{TC} are used for the UE to determine the cyclic shift value and the comb offset for each of the SRS port in the second symbol, the third

$${n}_{S R S}^{c s}$$

and the third k̅_{TC} are used for the UE to determine the cyclic shift value and the comb offset for each of the SRS port in the third symbol, and the fourth

$${n}_{S R S}^{c s}$$

and the fourth k̅_{TC} are used for the UE to determine the cyclic shift value and the comb offset for each of the SRS port in the fourth symbol. A same K_{TC} (comb size) is configured for the SRS resource. With this configuration, SRS port 0, 1 in each of the first, second, third and fourth symbol may determine different cyclic shift values and different comb offset values.

The SRS ports for the SRS transmission in each symbol (each of the first symbol, the second symbol, the third symbol and the fourth symbol) are associated with different UE antenna ports. There are two patterns for the association of the SRS ports for the SRS transmission with UE antenna ports.

Pattern 2-1: SRS ports p̅ᵢ=0, 1 (i.e., SRS ports 0, 1 in the first symbol) for the SRS resource transmission are associated with antenna ports 1000, 1001, respectively; SRS port p̅ᵢ=2, 3 (i.e., SRS ports 0, 1 in the second symbol) for the SRS resource transmission are associated with antenna ports 1002, 1003, respectively; SRS ports p̅ᵢ=4, 5 (i.e., SRS ports 0, 1 in the third symbol) for the SRS resource transmission are associated with antenna ports 1004, 1005, respectively; and SRS ports p̅ᵢ=6, 7 (i.e., SRS ports 0, 1 in the fourth symbol) for the SRS resource transmission are associated with antenna ports 1006, 1007, respectively.

Pattern 2-2: SRS ports p̅ᵢ=0, 1 (i.e., SRS ports 0, 1 in the first symbol) for the SRS resource transmission are associated with antenna ports 1000, 1004, respectively; SRS port p̅ᵢ=2, 3 (i.e., SRS ports 0, 1 in the second symbol) for the SRS resource transmission are associated with antenna ports 1001, 1005, respectively; SRS ports p̅ᵢ=4, 5 (i.e., SRS ports 0, 1 in the third symbol) for the SRS resource transmission are associated with antenna ports 1002, 1006, respectively; and SRS ports p̅ᵢ=6, 7 (i.e., SRS ports 0, 1 in the fourth symbol) for the SRS resource transmission are associated with antenna ports 1003, 1007, respectively. It can be seen from Pattern 2-2 that at least for partial coherent UE, all the antenna ports within a same coherent antenna group (e.g., antenna ports 1000, 1004 that are in a same coherent antenna group, antenna ports 1001, 1005 that are in a same coherent antenna group, antenna ports 1002, 1006 that are in a same coherent antenna group, and antenna ports 1003, 1007 that are in a same coherent antenna group: see FIG. 1(d)) are sounded in a same symbol.

A second embodiment relates to frequency hopping and repetition for 8 SRS ports sounding in multiple (e.g., 2 or 4) symbols.

Since each SRS resource transmission occupies more than one symbol (e.g., 2 symbols or 4 symbols), if frequency hopping and/or repetition are further configured for the SRS resource, the frequency hopping as well as repetition should be performed per SRS resource over all the symbols (e.g., over 2 symbols or 4 symbols).

It means that, for frequency hopping, if the SRS resource transmission occupies two symbols, the two symbols are hopped together; and if the SRS resource transmission occupies four symbols, the four symbols are hopped together.

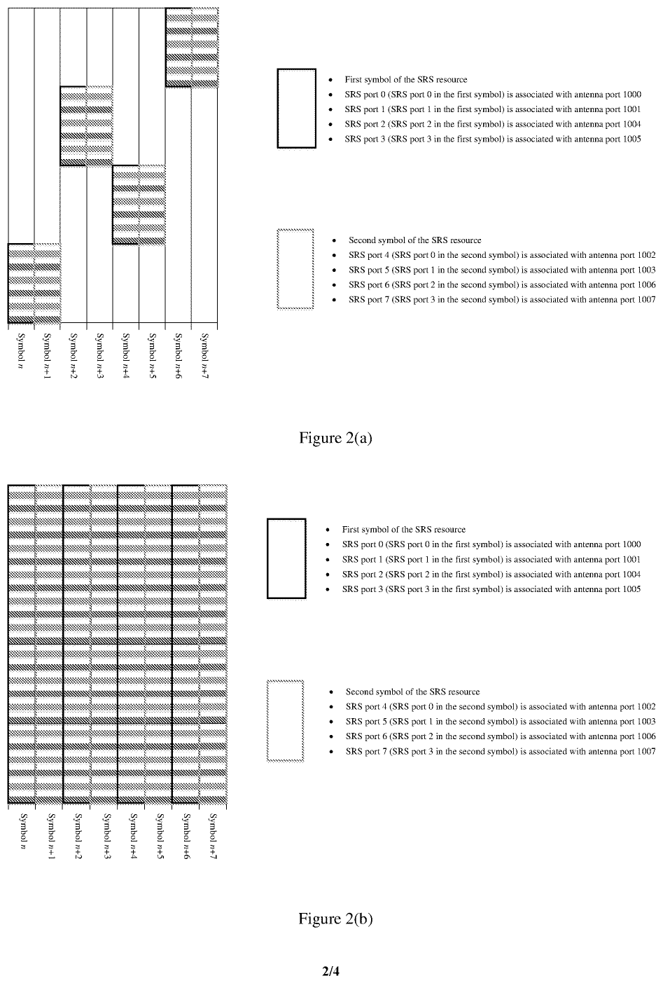

FIG. 2(a) illustrates an example of frequency hopping for an SRS resource transmission that occupies two symbols

$$( {N}_{s y m b}^{SRS , Resource} = 2 or {N}_{a p}^{S R S , symbol} = 4 ) .$$

The two symbols are hopped together.

The SRS ports in the first symbol and the SRS ports in the second symbol share the same comb offsets and the same cyclic shifts. It means that SRS port 0 (i.e., SRS port 0 in the first symbol) and SRS port 4 (i.e., SRS port 0 in the second symbol) have the same comb offset and the same cyclic shift; SRS port 1 (i.e., SRS port 1 in the first symbol) and SRS port 5 (i.e., SRS port 1 in the second symbol) have the same comb offset and the same cyclic shift; SRS port 2 (i.e., SRS port 2 in the first symbol) and SRS port 6 (i.e., SRS port 2 in the second symbol) have the same comb offset and the same cyclic shift; and SRS port 3 (i.e., SRS port 3 in the first symbol and SRS port 7 (i.e., SRS port 3 in the second symbol) have the same comb offset and the same cyclic shift.

On the other hand, the SRS ports of both symbols are associated with different antenna ports. In detail, SRS port 0 (i.e., SRS port 0 in the first symbol) and SRS port 4 (i.e., SRS port 0 in the second symbol) are associated with different antenna ports 1000 and 1002, respectively; SRS port 1 (i.e., SRS port 1 in the first symbol) and SRS port 5 (i.e., SRS port 1 in the second symbol) are associated with different antenna ports 1001 and 1003, respectively; SRS port 2 (i.e., SRS port 2 in the first symbol) and SRS port 6 (i.e., SRS port 2 in the second symbol) are associated with different antenna ports 1004 and 1006, respectively; and SRS port 3 (i.e., SRS port 3 in the first symbol and SRS port 7 (i.e., SRS port 3 in the second symbol) are associated with different antenna ports 1005 and 1007, respectively.

It can be seen from FIG. 2(a) that each hop occupies

$${N}_{s y m b}^{S R S Res o u r c e} = 2$$

symbols, and 8 symbols (2 symbols/hop*4 hops) are required for all 4 hops. In each of the four hops, all the 8 SRS ports of the same SRS resource should be sounded in

$${N}_{s y m b}^{S R S , Res o u r c e} = 2$$

adjacent symbols.

To ensure the UE to obtain the correct frequency position index when frequency hopping is further configured for the SRS resource, the SRS transmission counter n_{SRS} should be enhanced considering that each SRS transmission contains more than one symbol (e.g.,

$${N}_{symb}^{SRS , Resource} = 2$$

or 4 symbols) compared with single symbol sounding.

According to this disclosure, for aperiodic SRS resource,

$${n}_{S R S} = ⌊ \frac{{l}^{′}}{R \times {N}_{s y m b}^{SRS , Resource}} ⌋ ,$$

and for periodic and semi-persistent SRS resource,

$${n}_{S R S} = ( \frac{{N}_{slot}^{f r a m e , μ} {n}_{f} + {n}_{s , f}^{μ} - {T}_{offset}}{{T}_{S R S}} ) \cdot ( \frac{{N}_{s y m b}^{S R S}}{R \times {N}_{s y m b}^{SRS , Resource}} ) + ⌊ \frac{{l}^{′}}{R \times {N}_{s y m b}^{SRS , Resource}} ⌋ ,$$

where, l′=0, 1, . . . ,

$${N}_{s y m b}^{S R S} - 1 ,$$

R is the repetition factor configured for the SRS resource,
T_{SRS} and T_{offset} are the periodicity in slot and the slot offset configured for periodic and semi-persistent SRS resource,

$${N}_{s y m b}^{S R S}$$

consecutive OFDM symbols are configured for the SRS resource by RRC parameter nrofSymbols,

$${N}_{slot}^{frame , μ}$$

is the number of slots in a frame for subcarrier spacing configuration μ,
n_{f} is the frame numbering, and

$${n}_{s , f}^{μ} ∈ \{ 0 , … , {N}_{slot}^{f r a m e , μ} \}$$

is the slot numbering within a frame.

FIG. 2(b) illustrates an example of repetition for an SRS resource transmission that occupies two symbols. The two symbols are repeated together.

The configuration of comb offset, cyclic shift and the association of SRS ports with antenna ports in FIG. 2(b) is the same as that in FIG. 2(a).

It can be seen from FIG. 2(b) that each repetition occupies

$${N}_{s y m b}^{SRS , Resource} = 2$$

symbols, and 8 symbols (2 symbols/repetition*4 repetitions) are required for all 4 repetitions.

When the SRS resource is configured with repetition, the number of symbols (e.g., m) for the SRS resource transmission within a slot should be a multiple of

$${N}_{s y m b}^{SRS , Resource} .$$

In particular, for

$${N}_{s y m b}^{S R S , Res o u r c e} = 2 or {N}_{a p}^{S R S , s y mbol} = 4 ,$$

m=2, 4, 8, 10, 12, 14; while for

$${N}_{s y m b}^{SRS , Resource} = 4 or {N}_{a p}^{S R S , s y mbol} = 2 ,$$

m=4, 8, 12.

A third embodiment relates to power allocation for the SRS transmission.

In the condition that all the antenna ports are transmitted in one symbol, the UE splits a linear value \hat{P}_{SRS,bf,c}(i, qₛ, l) of the transmit power P_{SRS,bf,c}(i, qₛ, l) on active UL BWP b of carrier f of serving cell c equally across the configured antenna ports for SRS. That is, if all 8 antenna ports are transmitted in one symbol, the transmit power of each SRS port is \hat{P}_{SRS,bf,c}(i, qₛ, l)/8.

When the SRS resource is configured with 8 SRS ports over more than one symbol (e.g.,

$${N}_{s y m b}^{S R S , Res o u r c e} = 2$$

or 4 symbols), the UE should split a linear value \hat{P}_{SRS,bf,c}(i, qₛ, l) of the transmit power P_{SRS,bf,c}(i, qₛ, l) on active UL BWP b of carrier f of serving cell c equally across the configured antenna ports for this SRS transmission occasion i on one symbol, which is

$${\hat{P}}_{SRS , b , f , c} ( i , {q}_{s} , l ) / {N}_{a p}^{S R S , s y mbol}$$

for each SRS port. This can achieve the power domain gain for coverage enhancement.

In particular, when the 8 antenna ports are sounded in 2 symbols, the transmit power for each SRS port is

$${\hat{P}}_{SRS , b , f , c} ( i , {q}_{s} , l ) / {N}_{a p}^{S R S , s y mbol} = {\hat{P}}_{S R S , b , f , c} ( i , {q}_{s} , l ) / 4 ,$$

which is 3 dB power domain gain compared to \hat{P}_{SRS,bf,c}(i, qₛ, l)/8 if all the 8 antenna ports are sounded in one symbol.

Similarly, when the 8 antenna ports are sounded in 4 symbols, the transmit power for each SRS port is

$${\hat{P}}_{SRS , b , f , c} ( i , {q}_{s} , l ) / {N}_{a p}^{S R S , s y mbol} = {\hat{P}}_{S R S , b , f , c} ( i , {q}_{s} , l ) / 2 ,$$

which is 6 dB power domain gain compared to \hat{P}_{SRS,bf,c}(i, qₛ, l)/8 if all the 8 antenna ports are sounded in one symbol.

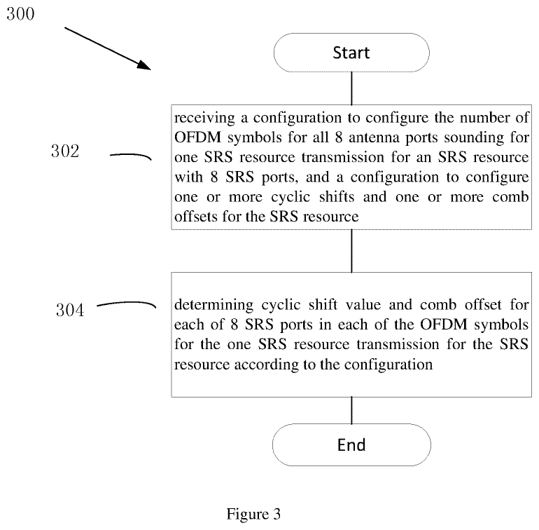

FIG. 3 is a schematic flow chart diagram illustrating an embodiment of a method 300 according to the present application. In some embodiments, the method 300 is performed by an apparatus, such as a remote unit. In certain embodiments, the method 300 may be performed by a processor executing program code, for example, a microcontroller, a microprocessor, a CPU, a GPU, an auxiliary processing unit, a FPGA, or the like.

The method 300 may comprise 302 receiving a configuration to configure the number of OFDM symbols

$$( {N}_{s y m b}^{S R S , Res o u r c e} )$$

for all 8 antenna ports sounding for one SRS resource transmission for an SRS resource with

$${N}_{a p}^{S R S} = 8 SRS ports ,$$

and a configuration to configure one or more cyclic shifts and one or more comb offsets for the SRS resource; and 304 determining cyclic shift value α_{p̅}_{ᵢ} and comb offset

$${k}_{T C}^{( {\overline{p}}_{i} )}$$

for each of 8 SRS ports in each of the OFDM symbols for the one SRS resource transmission for the SRS resource according to the configuration.

In some embodiment, the configuration is by directly configuring the number of OFDM symbols

$$( {N}_{s y m b}^{SRS , Resource} ) ,$$

which is 2 or 4. Alternatively, the configuration is by configuring the number of SRS ports in each OFDM symbol

$$( {N}_{a p}^{SRS , symbol} ) ,$$

which is equal to

$${N}_{a p}^{S R S} / {N}_{symb}^{SRS , Resource}$$

and is 4 or 2.

In some embodiment, the method further comprises splitting a linear value \hat{P}_{SRS,bf,c}(i, qₛ, l) of the transmit power P_{SRS,bf,c}(i, qₛ, l) on active UL BWP b of carrier f of serving cell c equally across

$${N}_{ap}^{RRS , symbol}$$

antenna ports for the SRS transmission in one OFDM symbol, where

$${N}_{ap}^{SRS , symbol} = {N}_{ap}^{SRS} / {N}_{symb}^{SRS , Resource} .$$

In some embodiment, each of SRS ports 0, . . . ,

$${N}_{ap}^{SRS , symbo1} - 1$$

in each OFDM symbol for all SRS resource transmission share a same cyclic shift value α_{p̅}_{ᵢ} and a same comb offset

$${k}_{T C}^{( {\overline{p}}_{i} )}$$

when a single cyclic shift and a single comb offset are configured for the SRS resource.

If

$${N}_{s y m b}^{SRS , Resource} = 2 ,$$

the cyclic shift values SRS port 0, 1, 2, 3 (p̅ᵢ=0, 1, 2, 3) in a first OFDM symbol and in a second OFDM symbol are determined according to

$${n}_{S R S}^{c s , {\overline{p}}_{i}} = \{ \begin{matrix}( {n}_{S R S}^{c s} + \frac{{n}_{S R S}^{cs , max} ⌊ {\overline{p}}_{i} / 2 ⌋}{{N}_{a p}^{S R S} / 2} ) mod {n}_{S R S}^{cs , max} & {n}_{S R S}^{cs , max} = 6 \\ ( {n}_{S R S}^{c s} + \frac{{n}_{S R S}^{cs , max} \times {\overline{p}}_{i}}{{N}_{a p}^{S R S}} ) mod {n}_{S R S}^{cs , max} & {n}_{S R S}^{cs , max} = 8 or 12\end{matrix} ,$$

where

$${n}_{S R S}^{c s}$$

is the single cyclic shift configured for the SRS resource.

If

$${N}_{s y m b}^{SRS , Resource} = 2 ,$$

the comb offsets for SRS port 0, 1, 2, 3 (p̅ᵢ=0, 1, 2, 3) in a first OFDM symbol and in a second OFDM symbol are determined according to

$$\{ \begin{matrix}{\overline{k}}_{T C} + {K}_{T C} / 2 ) mod {K}_{T C} & {\overline{p}}_{i} ∈ \{ 1 , 3 \} , {n}_{S R S}^{cs , max} = 6 \\ {\overline{k}}_{T C} + {K}_{T C} / 2 ) mod {K}_{T C} & {\overline{p}}_{i} ∈ \{ 1 , 3 \} , {n}_{S R S}^{c s} ∈ \{ {n}_{S R S}^{cs , max} / 2 , … , {n}_{S R S}^{c s ,} - 1 \} \\ {\overline{k}}_{T C} & \begin{matrix}{\overline{p}}_{i} ∈ \{ 1 , 3 \} , {n}_{S R S}^{c s} ∈ \{ 0 , … , {n}_{S R S}^{cs , max} / 2 \} \\ or {\overline{p}}_{i} ∈ \{ 0 , 2 \}\end{matrix}\end{matrix} ,$$

where K_{TC} is the comb size configured for the SRS resource, k̅_{TC} is the single comb offset configured for the SRS resource.

If

$${N}_{s y m b}^{SRS , Resource} = 4 ,$$

the cyclic shift values for SRS ports 0, 1 (p̅ᵢ=0, 1) in a first OFDM symbol, in a second OFDM symbol, in a third OFDM symbol and in a fourth OFDM symbol are determined according to

$${α}_{{\overline{p}}_{i}} = 2 π \frac{{n}_{SRS}^{cs , {\overline{p}}_{i}}}{{n}_{SRS}^{cs , max}} , where {n}_{SRS}^{cs , {\overline{p}}_{i}} = ( {n}_{SRS}^{cs} + \frac{{n}_{S R S}^{cs , max} \times {\overline{p}}_{i}}{{N}_{a p}^{SRS}} ) mod {n}_{S R S}^{cs , max} ,$$

where

$${n}_{SRS}^{cs}$$

is the single cyclic shift configured for the SRS resource.

If

$${N}_{s y m b}^{SRS , Resource} = 4 ,$$

the comb offsets for SRS ports 0, 1 (p̅ᵢ=0, 1) in a first OFDM symbol, in a second OFDM symbol, in a third OFDM symbol and in a fourth OFDM symbol are determined according to

$${k}_{TC}^{( {\overline{p}}_{i} )} = {\overline{k}}_{TC} ,$$

where k̅_{TC} is the single comb offset configured for the SRS resource.

In some embodiment, SRS port 0, . . . ,

$${N}_{a p}^{SRS , symbol} - 1$$

in each OFDM symbol for all SRS resource transmission are associated with different antenna ports.

In some embodiment, the method further comprises reporting a partial coherent capability with multiple antenna groups, and all antenna ports within a same antenna group are associated with the SRS ports of the SRS resource transmission in a same OFDM symbol.

In some embodiment, when the SRS resource is further configured with frequency hopping, the number of SRS transmissions is counted according to

$${n}_{S R S} = ⌊ \frac{l ′}{R \times {N}_{s y m b}^{SRS , Resource}} ⌋$$

for aperiodic SRS resource, or

$${n}_{S R S} = ( \frac{{N}_{slot}^{f r a m e , μ} {n}_{f} + {n}_{s , f}^{μ} - {T}_{offset}}{{T}_{S R S}} ) \cdot ( \frac{{N}_{s y m b}^{S R S}}{R \times {N}_{s y m b}^{SRS , Resource}} ) + ⌊ \frac{l ′}{R \times {N}_{s y m b}^{SRS , Resource}} ⌋$$

for periodic and semi-persistent SRS.

In some embodiment, when the SRS resource is further configured with repetition, the number of OFDM symbols for the SRS transmission is a multiple of

$${N}_{s y m}^{{SRS , Resource}_{}} .$$

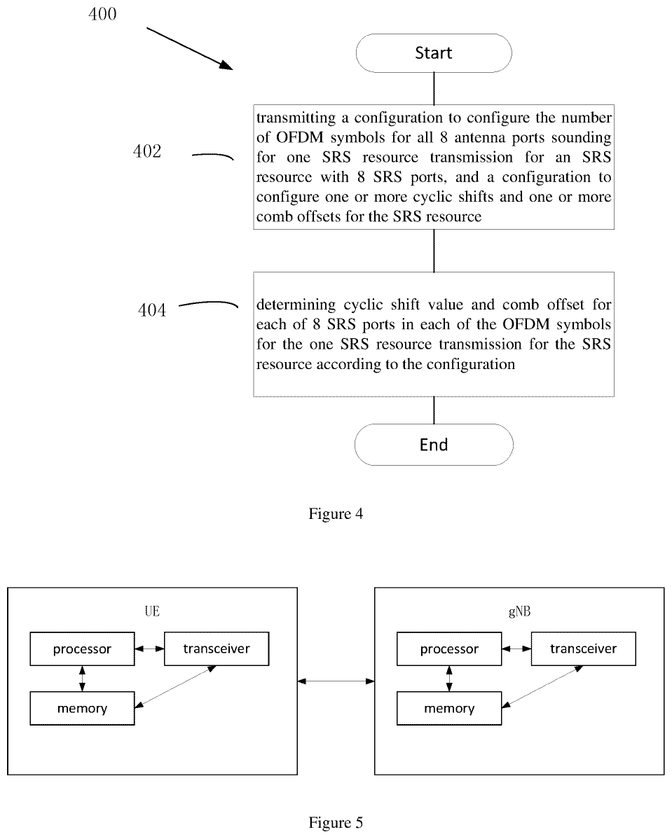

FIG. 4 is a schematic flow chart diagram illustrating a further embodiment of a method 400 according to the present application. In some embodiments, the method 400 is performed by an apparatus, such as a base unit. In certain embodiments, the method 400 may be performed by a processor executing program code, for example, a microcontroller, a microprocessor, a CPU, a GPU, an auxiliary processing unit, a FPGA, or the like.

The method 400 may comprise 402 transmitting a configuration to configure the number of OFDM symbols

$$( {N}_{s y m b}^{SRS , Resource} )$$

for all 8 antenna ports sounding for one SRS resource transmission for an SRS resource with

$${N}_{a p}^{S R S} = 8 SRS ports ,$$

and a configuration to configure one or more cyclic shifts and one or more comb offsets for the SRS resource; and 404 determining cyclic shift value α_{p̅}_{ᵢ} and comb offset

$${k}_{T C}^{( {\overline{p}}_{i} )}$$

for each of 8 SRS ports in each of the OFDM symbols for the one SRS resource transmission for the SRS resource according to the configuration.

In some embodiment, the configuration is by directly configuring the number of OFDM symbols

$$( {N}_{s y m b}^{SRS , Resource} ) ,$$

which is 2 or 4. Alternatively, the configuration is by configuring the number of SRS ports in each OFDM symbol

$$( {N}_{a p}^{S R S , symbol} ) ,$$

which is equal to

$${N}_{a p}^{S R S} / {N}_{symb}^{SRS , Resource}$$

and is 4 or 2.

In some embodiment, the method further comprises splitting a linear value \hat{P}_{SRS,bf,c}(i, qₛ, l) of the transmit power P_{SRS,bf,c}(i, qₛ, l) on active UL BWP b of carrier f of serving cell c equally across

$${N}_{ap}^{SRS , symbol}$$

antenna ports for the SRS transmission in one OFDM symbol, where

$${N}_{a p}^{SRS , symbol} = {N}_{a p}^{S R S} / {N}_{s y m b}^{SRS , Resource} .$$

In some embodiment, each of SRS ports 0, . . . ,

$${N}_{a p}^{S R S , symbol} - 1$$

in each OFDM symbol for all SRS resource transmission share a same cyclic shift value α_{p̅}_{ᵢ} and a same comb offset

$${k}_{T C}^{( {\overline{p}}_{i} )}$$

when a single cyclic shift and a single comb offset are configured for the SRS resource.

If

$${N}_{s y m b}^{SRS , Resource} = 2 ,$$

the cyclic shift values SRS port 0, 1, 2, 3 (p̅ᵢ=0, 1, 2, 3) in a first OFDM symbol and in a second OFDM symbol are determined according to

$${n}_{S R S}^{c s , {\overline{p}}_{i}} = \{ \begin{matrix}( {n}_{S R S}^{c s} + \frac{{n}_{S R S}^{cs , max} ⌊ {\overline{p}}_{i} / 2 ⌋}{{N}_{a p}^{S R S} / 2} ) mod {n}_{S R S}^{cs , max} & {n}_{S R S}^{cs , max} = 6 \\ ( {n}_{S R S}^{c s} + \frac{{n}_{S R S}^{cs , max} \times {\overline{p}}_{i}}{{N}_{a p}^{S R S}} ) mod {n}_{S R S}^{cs , max} & {n}_{S R S}^{cs , max} = 8 or 12\end{matrix} , \begin{matrix} \\ \end{matrix}$$

where

$${n}_{S R S}^{c s}$$

is the single cyclic shift configured for the SRS resource.

If

$${N}_{s y m b}^{SRS , Resource} = 2 ,$$

the comb offsets for SRS port 0, 1, 2, 3 (p̅ᵢ=0, 1, 2, 3) in a first OFDM symbol and in a second OFDM symbol are determined according to

$$\{ \begin{matrix}( {\overline{k}}_{T C} + {K}_{T C} / 2 ) mod {K}_{T C} & {\overline{p}}_{i} ∈ \{ 1 , 3 \} , {n}_{S R S}^{cs , max} = 6 \\ ( {\overline{k}}_{T C} + {K}_{T C} / 2 ) mod {K}_{T C} & {\overline{p}}_{i} ∈ \{ 1 , 3 \} , {n}_{S R S}^{c s} ∈ \{ {n}_{S R S}^{cs , max} / 2 , … , {n}_{S R S}^{cs , max} - 1 \} \\ {\overline{k}}_{T C} & {\overline{p}}_{i} ∈ \{ 1 , 3 \} , {n}_{S R S}^{c s} ∈ \{ 0 , … , {n}_{S R S}^{cs , max} / 2 \} or {\overline{p}}_{i} ∈ \{ 0 , 2 \}\end{matrix} ,$$

where K_{TC} is the comb size configured for the SRS resource, k̅_{TC} is the single comb offset configured for the SRS resource.

If

$${N}_{s y m b}^{SRS , Resource} = 4 ,$$

the cyclic shift values for SRS ports 0, 1 (p̅ᵢ=0, 1) in a first OFDM symbol, in a second OFDM symbol, in a third OFDM symbol and in a fourth OFDM symbol are determined according to

$${α}_{{\overline{p}}_{i}} = 2 π \frac{{n}_{SRS}^{cs , {\overline{p}}_{i}}}{{n}_{S R S}^{cs , max}} , where {n}_{S R S}^{c s , {\overline{p}}_{i}} = ( {n}_{S R S}^{c s} + \frac{{n}_{S R S}^{cs , max} \times {\overline{p}}_{i}}{{N}_{a p}^{S R S}} ) mod {n}_{S R S}^{cs , max} ,$$

where

$${n}_{SRS}^{c s}$$

is the single cyclic shift configured for the SRS resource.

If

$${N}_{s y m b}^{SRS , Resource} = 4 ,$$

the comb offsets for SRS ports 0, 1 (p̅ᵢ=0, 1) in a first OFDM symbol, in a second OFDM symbol, in a third OFDM symbol and in a fourth OFDM symbol are determined according to

$${k}_{T C}^{( {\overline{p}}_{i} )} = {\overline{k}}_{T C} ,$$

where k̅_{TC} is the single comb offset configured for the SRS resource.

In some embodiment, SRS port 0, . . . ,

$${N}_{a p}^{S R S , symbol} - 1$$

in each OFDM symbol for all SRS resource transmission are associated with different antenna ports.

In some embodiment, the method further comprises receiving a partial coherent capability with multiple antenna groups, and all antenna ports within a same antenna group are associated with the SRS ports of the SRS resource transmission in a same OFDM symbol.

In some embodiment, when the SRS resource is further configured with frequency hopping, the number of SRS transmissions is counted according to

$${n}_{S R S} = ⌊ \frac{l ′}{R \times {N}_{s y m b}^{SRS , Resource}} ⌋$$

for aperiodic SRS resource, or

$${n}_{S R S} = ( \frac{{N}_{slot}^{f r a m e , μ} {n}_{f} + {n}_{s , f}^{μ} - {T}_{offset}}{{T}_{S R S}} ) \cdot ( \frac{{N}_{s y m b}^{S R S}}{R \times {N}_{s y m b}^{SRS , Resource}} ) + ⌊ \frac{l ′}{R \times {N}_{s y m b}^{SRS , Resource}} ⌋$$

for periodic and semi-persistent SRS.

In some embodiment, when the SRS resource is further configured with repetition, the number of OFDM symbols for the SRS transmission is a multiple of

$${N}_{s y m}^{SRS , Resource} .$$

FIG. 5 is a schematic block diagram illustrating apparatuses according to one embodiment.

Referring to FIG. 5, the UE (i.e. the remote unit) includes a processor, a memory, and a transceiver. The processor implements a function, a process, and/or a method which are proposed in FIG. 3.

A user equipment (UE) comprises a transceiver; and a processor coupled to the transceiver, wherein the processor is configured to receive, via the transceiver, a configuration to configure the number of OFDM symbols

$$( {N}_{s y m b}^{SRS , Resource} )$$

for all 8 antenna ports sounding for one SRS resource transmission for an SRS resource with

$${N}_{a p}^{S R S} = 8 SRS ports ,$$

and a configuration to configure one or more cyclic shifts and one or more comb offsets for the SRS resource; and determine cyclic shift value α_{p̅}_{ᵢ} and comb offset

$${k}_{T C}^{( {\overline{p}}_{i} )}$$

for each of 8 SRS ports in each of the OFDM symbols for the one SRS resource transmission for the SRS resource according to the configuration.

In some embodiment, the configuration is by directly configuring the number of OFDM symbols

$$( {N}_{s y m b}^{SRS , Resource} ) ,$$

which is 2 or 4. Alternatively, the configuration is by configuring the number of SRS ports in each OFDM symbol

$$( {N}_{ap}^{SRS , symbol} ) ,$$

which is equal to

$${N}_{ap}^{SRS} / {N}_{symb}^{SRS , Resource}$$

and is 4 or 2.

In some embodiment, the processor is further configured to split a linear value \hat{P}_{SRS,bf,c}(i, qₛ, l) of the transmit power P_{SRS,bf,c}(i, qₛ, l) on active UL BWP b of carrier f of serving cell c equally across

$${N}_{ap}^{SRS , symbol}$$

antenna ports for the SRS transmission in one OFDM symbol, where

$${N}_{ap}^{SRS , symbol} = {N}_{ap}^{SRS} / {N}_{symb}^{SRS , Resource} .$$

In some embodiment, each of SRS ports 0, . . . ,

$${N}_{ap}^{SRS , symbol} - 1$$

in each OFDM symbol for all SRS resource transmission share a same cyclic shift value α_{p̅}_{ᵢ} and a same comb offset

$${k}_{TC}^{( {\overline{p}}_{i} )}$$

when a single cyclic shift and a single comb offset are configured for the SRS resource.

If

$${N}_{symb}^{SRS , Resource} = 2 ,$$

the cyclic shift values SRS port 0, 1, 2, 3 (p̅ᵢ=0, 1, 2, 3) in a first OFDM symbol and in a second OFDM symbol are determined according to

$${n}_{SRS}^{cs , {\overline{p}}_{i}} = \{ \begin{matrix}( {n}_{SRS}^{cs} + \frac{{n}_{SRS}^{cs , max} ⌊ {\overline{p}}_{i} / 2 ⌋}{{N}_{ap}^{SRS} / 2} ) mod {n}_{SRS}^{cs , max} & {n}_{SRS}^{cs , max} = 6 \\ ( {n}_{SRS}^{cs} + \frac{{n}_{SRS}^{cs , max} \times {\overline{p}}_{i}}{{N}_{ap}^{SRS}} ) mod {n}_{SRS}^{cs , max} & {n}_{SRS}^{cs , max} = 8 or 12\end{matrix} ,$$

where

$${n}_{SRS}^{cs}$$

is the single cyclic shift configured for the SRS resource.

If

$${N}_{symb}^{SRS , Resource} = 2 ,$$

the comb offsets for SRS port 0, 1, 2, 3 (p̅ᵢ=0, 1, 2, 3) in a first OFDM symbol and in a second OFDM symbol are determined according to

$$\{ \begin{matrix}( {\overline{k}}_{TC} + {K}_{TC} / 2 ) mod {K}_{TC} & {\overline{p}}_{i} ∈ \{ 1 , 3 \} , {n}_{SRS}^{cs , max} = 6 \\ ( {\overline{k}}_{TC} + {K}_{TC} / 2 ) mod {K}_{TC} & {\overline{p}}_{i} ∈ \{ 1 , 3 \} , {n}_{SRS}^{cs} ∈ \{ {n}_{SRS}^{cs , max} / 2 , … , {n}_{SRS}^{cs , max} - 1 \} \\ {\overline{k}}_{T C} & {\overline{p}}_{i} ∈ \{ 1 , 3 \} , {n}_{SRS}^{cs} ∈ \{ 0 , … , {n}_{SRS}^{cs , max} / 2 \} or {\overline{p}}_{i} ∈ \{ 0 , 2 \}\end{matrix} ,$$

where K_{TC} is the comb size configured for the SRS resource, k̅_{TC} is the single comb offset configured for the SRS resource.

If

$${N}_{symb}^{SRS , Resource} = 4 ,$$

the cyclic shift values for SRS ports 0, 1 (p̅ᵢ=0, 1) in a first OFDM symbol, in a second OFDM symbol, in a third OFDM symbol and in a fourth OFDM symbol are determined according to

$${α}_{{\overline{p}}_{i}} = 2 π \frac{{n}_{SRS}^{cs , {\overline{p}}_{i}}}{{n}_{SRS}^{cs , max}} , where {n}_{SRS}^{cs , {\overline{p}}_{i}} = ( {n}_{SRS}^{cs} + \frac{{n}_{SRS}^{cs , max} \times {\overline{p}}_{i}}{{N}_{ap}^{SRS}} ) mod {n}_{SRS}^{cs , max} ,$$

where

$${n}_{SRS}^{cs}$$

is the single cyclic shift configured for the SRS resource.

If

$${N}_{symb}^{SRS , Resource} = 4 ,$$

the comb offsets for SRS ports 0, 1 (p̅ᵢ=0, 1) in a first OFDM symbol, in a second OFDM symbol, in a third OFDM symbol and in a fourth OFDM symbol are determined according to

$${k}_{T C}^{( {\overline{p}}_{i} )} = {\overline{k}}_{T C} ,$$

where k̅_{TC} is the single comb offset configured for the SRS resource.

In some embodiment, SRS port 0, . . . ,

$${N}_{a p}^{SRS , symbol} - 1$$

in each OFDM symbol for all SRS resource transmission are associated with different antenna ports.

In some embodiment, the processor is further configured to report a partial coherent capability with multiple antenna groups, and all antenna ports within a same antenna group are associated with the SRS ports of the SRS resource transmission in a same OFDM symbol.

In some embodiment, when the SRS resource is further configured with frequency hopping, the number of SRS transmissions is counted according to

$${n}_{S R S} = ⌊ \frac{l ′}{R \times {N}_{symb}^{SRS , Resource}} ⌋$$

for aperiodic SRS resource, or

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{s y m b}^{S R S}}{R \times {N}_{symb}^{SRS , Resource}} ) + ⌊ \frac{l ′}{R \times {N}_{symb}^{SRS , Resource}} ⌋$$

for periodic and semi-persistent SRS.

In some embodiment, when the SRS resource is further configured with repetition, the number of OFDM symbols for the SRS transmission is a multiple of

$${N}_{symb}^{SRS , Resource} .$$

Referring to FIG. 5, the gNB (i.e. base unit) includes a processor, a memory, and a transceiver. The processor implements a function, a process, and/or a method which are proposed in FIG. 4.

A base unit comprises a transceiver; and a processor coupled to the transceiver, wherein the processor is configured to transmit, via the transceiver, a configuration to configure the number of OFDM symbols

$$( {N}_{s y m b}^{SRS , Resource} )$$

for all 8 antenna ports sounding for one SRS resource transmission for an SRS resource with

$${N}_{a p}^{SRS} = 8 SRS ports ,$$

and a configuration to configure one or more cyclic shifts and one or more comb offsets for the SRS resource; and determine cyclic shift value α_{p̅}_{ᵢ} and comb offset

$${k}_{T C}^{( {\overline{p}}_{i} )}$$

for each of 8 SRS ports in each of the OFDM symbols for the one SRS resource transmission for the SRS resource according to the configuration.

In some embodiment, the configuration is by directly configuring the number of OFDM symbols

$$( {N}_{symb}^{SRS , Resource} ) ,$$

which is 2 or 4. Alternatively, the configuration is by configuring the number of SRS ports in each OFDM symbol

$$( {N}_{ap}^{SRS , symbol} ) ,$$

which is equal to

$${N}_{ap}^{SRS} / {N}_{symb}^{SRS , Resource}$$

and is 4 or 2.

In some embodiment, the processor is further configured to split a linear value \hat{P}_{SRS,bf,c}(i, qₛ, l) of the transmit power P_{SRS,bf,c}(i, qₛ, l) on active UL BWP b of carrier f of serving cell c equally across

$${N}_{ p}^{SRS , symbol}$$

antenna ports for the SRS transmission in one OFDM symbol, where

$${N}_{a p}^{SRS , symbol} = {N}_{a p}^{SRS} / {N}_{s y m b}^{SRS , Resource} .$$

In some embodiment, each of SRS ports 0, . . . ,

$${N}_{a p}^{SRS , symbol} - 1$$

in each OFDM symbol for all SRS resource transmission share a same cyclic shift value α_{p̅}_{ᵢ} and a same comb offset

$${k}_{T C}^{( {\overline{p}}_{i} )}$$

when a single cyclic shift and a single comb offset are configured for the SRS resource.

If

$${N}_{s y m b}^{SRS , Resource} = 2 ,$$

the cyclic shift values SRS port 0, 1, 2, 3 (p̅ᵢ=0, 1, 2, 3) in a first OFDM symbol and in a second OFDM symbol are determined according to

$${n}_{S R S}^{c s , {\overline{p}}_{i}} = \{ \begin{matrix}( {n}_{S R S}^{c s} + \frac{{n}_{S R S}^{cs , max} ⌊ {\overline{p}}_{i} / 2 ⌋}{{N}_{a p}^{S R S} / 2} ) mod {n}_{S R S}^{cs , max} & {n}_{S R S}^{cs , max} = 6 \\ ( {n}_{S R S}^{c s} + \frac{{n}_{S R S}^{cs , max} \times {\overline{p}}_{i}}{{N}_{a p}^{S R S}} ) mod {n}_{S R S}^{cs , max} & {n}_{S R S}^{cs , max} = 8 or 12\end{matrix} ,$$

where

$${n}_{S R S}^{c s}$$

is the single cyclic shift configured for the SRS resource.

If

$${N}_{s y m b}^{SRS , Resource} = 2 ,$$

the comb offsets for SRS port 0, 1, 2, 3 (p̅ᵢ=0, 1, 2, 3) in a first OFDM symbol and in a second OFDM symbol are determined according to

$$\{ \begin{matrix}( {\overline{k}}_{T C} + {K}_{T C} / 2 ) mod {K}_{T C} & {\overline{p}}_{i} ∈ \{ 1 , 3 \} , {n}_{S R S}^{cs , max} = 6 \\ ( {\overline{k}}_{T C} + {K}_{T C} / 2 ) mod {K}_{T C} & {\overline{p}}_{i} ∈ \{ 1 , 3 \} , {n}_{S R S}^{c s} ∈ \{ {n}_{S R S}^{c s ,} / 2 , … , {n}_{S R S}^{cs , max} - 1 \} \\ {\overline{k}}_{T C} & \begin{matrix}{\overline{p}}_{i} ∈ \{ 1 , 3 \} , {n}_{S R S}^{c s} ∈ \{ 0 , … , {n}_{S R S}^{cs , max} / 2 \} or \\ {\overline{p}}_{i} ∈ \{ 0 , 2 \}\end{matrix}\end{matrix} ,$$

where K_{TC} is the comb size configured for the SRS resource, k̅_{TC} is the single comb offset configured for the SRS resource.

If

$${N}_{s y m b}^{SRS , Resource} = 4 ,$$

the cyclic shift values for SRS ports 0, 1 (p̅ᵢ=0, 1) in a first OFDM symbol, in a second OFDM symbol, in a third OFDM symbol and in a fourth OFDM symbol are determined according to

$${α}_{{\overline{p}}_{i}} = 2 π \frac{{n}_{SRS}^{cs , {\overline{p}}_{i}}}{{n}_{S R S}^{cs , max}} where {n}_{S R S}^{c s , {\overline{p}}_{i}} = ( {n}_{S R S}^{c s} + \frac{{n}_{S R S}^{cs , max} \times {\overline{p}}_{i}}{{N}_{a p}^{S R S}} ) mod {n}_{S R S}^{cs , max} ,$$

where

$${n}_{S R S}^{c s}$$

is the single cyclic shift configured for the SRS resource.

If

$${N}_{s y m b}^{SRS , Resource} = 4 ,$$

the comb offsets for SRS ports 0, 1 (p̅ᵢ=0, 1) in a first OFDM symbol, in a second OFDM symbol, in a third OFDM symbol and in a fourth OFDM symbol are determined according to

$${k}_{T C}^{( {\overline{p}}_{i} )} = {\overline{k}}_{T C} ,$$

where k̅_{TC} is the single comb offset configured for the SRS resource.

In some embodiment, SRS port 0, . . . ,

$${N}_{a p}^{S R S , symbol} - 1$$

in each OFDM symbol for all SRS resource transmission are associated with different antenna ports.

In some embodiment, the processor is further configured to receive a partial coherent capability with multiple antenna groups, and all antenna ports within a same antenna group are associated with the SRS ports of the SRS resource transmission in a same OFDM symbol.

In some embodiment, when the SRS resource is further configured with frequency hopping, the number of SRS transmissions is counted according to

$${n}_{S R S} = ⌊ \frac{{l}^{′}}{R \times {N}_{s y m b}^{SRS , Resource}} ⌋$$

for aperiodic SRS resource, or

$${n}_{S R S} = ( \frac{{N}_{slot}^{f r a m e , μ} {n}_{f} + {n}_{s , f}^{μ} - {T}_{offset}}{{T}_{S R S}} ) .$$

$$( \frac{{N}_{s y m b}^{S R S}}{R \times {N}_{s y m b}^{SRS , Resource}} ) + ⌊ \frac{{l}^{′}}{R \times {N}_{s y m b}^{SRS , Resource}} ⌋$$

for periodic and semi-persistent SRS.

In some embodiment, when the SRS resource is further configured with repetition, the number of OFDM symbols for the SRS transmission is a multiple of

$${N}_{symb}^{SRS , Resour c e} .$$

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a first configuration to determine a number of orthogonal frequency division multiplexing (OFDM) symbols for 8 antenna ports sounding for one sounding reference signal (SRS) resource transmission for an SRS resource with 8 SRS ports, and a second configuration to configure one or more cyclic shifts and one or more comb offsets for the SRS resource; and
split a linear value \hat{P}_{SRS,bf,c}(i, qₛ, l) of a transmit power P_{SRS,bf,c}(i, qₛ, l) on an active uplink (UL) bandwidth part (BWP) b of a carrier f of a serving cell c equally across 4 antenna ports for an SRS transmission in one OFDM symbol, when the 8 antenna ports are transmitted by two OFDM symbols.

2. The UE of claim 1, wherein the first configuration directly configures the number of OFDM symbols, wherein the number of OFDM symbols is 2 or 4.

3. The UE of claim 1, wherein the configuration configures a number of SRS ports in each OFDM symbol, wherein the number of SRS ports in each OFDM symbol is 4 or 2.

4. (canceled)

5. The UE of claim 1, wherein each SRS port of multiple SRS ports 0, . . . ,
$${N}_{a p}^{S R S , symbol} - 1$$
in each OFDM symbol of the number of OFDM symbols for all SRS resource transmission share a same cyclic shift value α_{p̅}_{ᵢ} and a same comb offset
$${k}_{T C}^{( {\overline{p}}_{i} )}$$
when a single cyclic shift and a single comb offset are configured for the SRS resource.

6. The UE of claim 5, wherein if the number of OFDM symbols is 2, cyclic shift values for SRS port 0, 1, 2, 3 (p̅ᵢ=0, 1, 2, 3) in a first OFDM symbol and in a second OFDM symbol are determined according to
$${n}_{SRS}^{cs , {\overline{p}}_{i}} = \{ \begin{matrix}( {n}_{SRS}^{cs} + \frac{{n}_{SRS}^{cs , max} ⌊ {\overline{p}}_{i} / 2 ⌋}{{N}_{ap}^{SRS} / 2} ) mod {n}_{SRS}^{cs , max} & {n}_{SRS}^{cs , max} = 6 \\ ( {n}_{SRS}^{cs} + \frac{{n}_{SRS}^{cs , max} \times {\overline{p}}_{i}}{{N}_{ap}^{SRS}} ) mod {n}_{SRS}^{cs , max} & {n}_{SRS}^{cs , max} = 8 or 12\end{matrix} ,$$
wherein
$${n}_{SRS}^{cs}$$
is the single cyclic shift configured for the SRS resource.

7. The UE of claim 5, wherein if the number of OFDM symbols is 2, comb offsets for SRS port 0, 1, 2, 3 (p̅ᵢ=0, 1, 2, 3) in a first OFDM symbol and in a second OFDM symbol are determined according
$$to \{ \begin{matrix}( {\overline{k}}_{TC} + {K}_{TC} / 2 ) mod {K}_{TC} & {\overline{p}}_{i} ∈ \{ 1 , 3 \} , {n}_{SRS}^{cs , max} = 6 \\ ( {\overline{k}}_{TC} + {K}_{TC} / 2 ) mod {K}_{TC} & {\overline{p}}_{i} ∈ \{ 1 , 3 \} , {n}_{SRS}^{cs} ∈ \{ {n}_{SRS}^{cs , max} / 2 , … , {n}_{SRS}^{cs , max} - 1 \} \\ {\overline{k}}_{TC} & \begin{matrix}{\overline{p}}_{i} ∈ \{ 1 , 3 \} , {n}_{SRS}^{cs} ∈ \\ \{ 0 , … , {n}_{SRS}^{cs , max} / 2 \} or {\overline{p}}_{i} ∈ \{ 0 , 2 \}\end{matrix}\end{matrix} ,$$
wherein K_{TC} is a comb size configured for the SRS resource, and k̅_{TC} is the single comb offset configured for the SRS resource.

8. The UE of claim 5, wherein if the number of OFDM symbols is 4, cyclic shift values for SRS ports 0, 1 (p̅ᵢ=0, 1) in a first OFDM symbol, in a second OFDM symbol, in a third OFDM symbol and in a fourth OFDM symbol are determined according to
$${α}_{{\overline{p}}_{i}} = 2 π \frac{{n}_{SRS}^{cs , {\overline{p}}_{i}}}{{n}_{SRS}^{cs , max}} , where {n}_{SRS}^{cs , {\overline{p}}_{i}} = ( {n}_{SRS}^{cs} + \frac{{n}_{SRS}^{cs , max} \times {\overline{p}}_{i}}{{N}_{ap}^{SRS}} ) mod {n}_{SRS}^{cs , max} ,$$
wherein
$${n}_{SRS}^{cs}$$
is the single cyclic shift configured for the SRS resource.

9. The UE of claim 5, wherein if the number of OFDM symbols is 4, comb offsets for SRS ports 0, 1 (p̅ᵢ=0, 1) in a first OFDM symbol, in a second OFDM symbol, in a third OFDM symbol and in a fourth OFDM symbol are determined according to
$${k}_{TC}^{( {\overline{p}}_{i} )} = {\overline{k}}_{TC} ,$$
where k̅_{TC} is the single comb offset configured for the SRS resource.

10. The UE of claim 1, wherein the SRS ports in each OFDM symbol for all SRS resource transmissions are associated with different antenna ports.

11. The UE of claim 1, wherein the at least one processor is further configured to cause the UE to report a partial coherent capability with multiple antenna groups, and wherein all antenna ports within a same antenna group are associated with the SRS ports of SRS resource transmissions in a same OFDM symbol.

12. The UE of claim 1, wherein when the SRS resource is further configured with frequency hopping, a number of SRS transmissions is counted according to
$${n}_{SRS} = ⌊ \frac{{l}^{′}}{R \times {N}_{symb}^{SRS , Resource}} ⌋$$
for aperiodic SRS resource, or
$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R \times {N}_{symb}^{SRS , Resource}} ) + ⌊ \frac{{l}^{′}}{R \times {N}_{symb}^{SRS , Resource}} ⌋$$
for periodic and semi-persistent SRS, wherein, l′=0, 1, . . . ,
$${N}_{symb}^{SRS} - 1 ,$$
wherein R is a repetition factor configured for the SRS resource, wherein T_{SRS} and T_{offset} are a periodicity in slot and a slot offset configured for periodic and semi-persistent SRS resource, wherein
$${N}_{symb}^{SRS}$$
consecutive OFDM symbols are configured for the SRS resource by a radio resource control (RRC) parameter nrofSymbols, wherein
$${N}_{slot}^{frame , μ}$$
is a number of slots in a frame for subcarrier spacing configuration μ, wherein n_{f} is a frame numbering, and wherein
$${n}_{s , f}^{μ} ∈ \{ 0 , … , {N}_{slot}^{frame , μ} \}$$
is a slot numbering within a frame.

13. The UE of claim 1, wherein when the SRS resource is further configured with repetition, the number of OFDM symbols for the SRS transmission is a multiple of the number of OFDM symbols.

14. A method performed by a user equipment (UE), the method comprising:
receiving a first configuration to configure a number of orthogonal frequency division multiplexing (OFDM) symbols for 8 antenna ports sounding for one sounding reference signal (SRS) resource transmission for an SRS resource with 8 SRS ports, and a second configuration to configure one or more cyclic shifts and one or more comb offsets for the SRS resource; and
splitting a linear value \hat{P}_{SRS,bf,c}(i, gₛ, l) of a transmit power \hat{P}_{SRS,bf,c}(i, qₛ, l) on an active uplink (UL) bandwidth part (BWP) b of a carrier f of a serving cell c equally across 4 antenna ports for an SRS transmission in one OFDM symbol, when the 8 antenna ports are transmitted by two OFDM symbols.

15. A base unit, comprising:
at least one memory; and
at least one processor coupled with the at least one memory and configured to cause the base unit to:
transmit a first configuration to determine a number of orthogonal frequency division multiplexing (OFDM) symbols for 8 antenna ports sounding for one sounding reference signal (SRS) resource transmission for an SRS resource with 8 SRS ports, and a second configuration to configure one or more cyclic shifts and one or more comb offsets for the SRS resource; and
determine a cyclic shift value and a comb offset for each of the 8 SRS ports in each of the OFDM symbols for the one SRS resource transmission for the SRS resource according to the first configuration and the second configuration.

16. A method performed by a base unit, the method comprising:
transmitting a first configuration to determine a number of orthogonal frequency division multiplexing (OFDM) symbols for 8 antenna ports sounding for one sounding reference signal (SRS) resource transmission for an SRS resource with 8 SRS ports, and a second configuration to configure one or more cyclic shifts and one or more comb offsets for the SRS resource; and
determine a cyclic shift value and a comb offset for each of the 8 SRS ports in each of the OFDM symbols for the one SRS resource transmission for the SRS resource according to the first configuration and the second configuration.

17. The method of claim 14, wherein the first configuration directly configures the number of OFDM symbols, wherein the number of OFDM symbols is 2 or 4.

18. The method of claim 14, wherein the configuration configures a number of SRS ports in each OFDM symbol, wherein the number of SRS ports in each OFDM symbol is 4 or 2.

19. The method of claim 14, wherein each SRS port of multiple SRS ports 0, . . . ,
$${N}_{ap}^{SRS , symbol} - 1$$
in each OFDM symbol of the number of OFDM symbols for all SRS resource transmission share a same cyclic shift value α_{p̅}_{ᵢ} and a same comb offset
$${k}_{TC}^{( {\overline{p}}_{i} )}$$
when a single cyclic shift and a single comb offset are configured for the SRS resource.

20. The method of claim 14, wherein the SRS ports in each OFDM symbol for all SRS resource transmissions are associated with different antenna ports.

21. The method of claim 14, further comprising reporting a partial coherent capability with multiple antenna groups, and wherein all antenna ports within a same antenna group are associated with the SRS ports of SRS resource transmissions in a same OFDM symbol.
